(19) United States
(12) Patent Application Publication
(10) Pub. No.: US 2010/0112207 A1
(43) Pub. Date: May 6, 2010

(54) Process for thermal spraying the internal surface of a kort nozzle in situ

(76) Inventor: Thomas Gardega, Conway, SC (US)

Correspondence Address: DILWORTH & BARRESE, LLP, 1000 WOODBURY ROAD, SUITE 405, WOODBURY, NY, 11797, US

(21) Appl. No.: 12/290,726

(22) Filed: Nov. 3, 2008

(51) Int. Cl. B05D 7/22

(52) U.S. Cl. 427/235; 427/236

(57) ABSTRACT

The present invention is directed to a process and apparatus for thermally spray coating the inside surface of a hydro-drive device, namely a Kort, so as to improve hydro-flow thrust and reduce the consumption of fuel for a vessel comprising the adapted Kort. The process of the present invention comprises thermally spraying a thermoplastic material in the area of the interior wall of the Kort that comes in close proximity to the propeller of the hydro-drive device. The closer the propeller comes to the interior wall of the Kort, the less friction and cavitations produced. Since friction and cavitations increases fuel consumption of the vessel, any reduction in the clearance between the wall of the Kort and the propeller tips directly reduces fuel consumption. At the same time, a reduction in clearance also increases the thrust of the hydro-drive device.

### CROSS-REFERENCE TO RELATED APPLICATIONS

This application claims priority to U.S. provisional patent application Ser. No. 60/001,510 filed Nov. 1, 2007.

### FIELD OF THE INVENTION

The present invention relates to a process and an apparatus for thermally spray-coating the inside surface of a hydro-drive device, namely a Kort Nozzle, so as to improve hydro-flow thrust and reduce fuel consumption of vessels comprising the adapted Kort.

### BACKGROUND OF THE INVENTION

Many large Marine vessels have at least one Kort nozzle as part of their hydro-drive device. Kort nozzles are used on thousands of fishing boats, supply vessels, inland river boats and passenger boats around the world. This nozzle is a cylindrical tube that surrounds a screw propeller and provides increased control of the water turbulence passing through it. Designed according to the principles of physics regarding fluid velocity, the Kort nozzle has a wide diameter at the intake and is thinnest at the center where the propeller turns. The diameter is also thinner at the outlet than at the inlet so that there is an increase in net velocity and energy of the water flow, leading to greater propeller efficiency.

The gap between the propeller blade tips and the nozzle barrel is designed to ensure that the propellers do not come into direct contact with the Kort nozzle barrel due to metal shrinkage or caused by welding, inaccurate rolling, crude manufacturing and methods. However, this gap also reduces the amount of thrust available to the vessel and therefore increases fuel consumption. Closing this gap will clearly increase the efficiency of the propeller and the propulsion of the vessel. One way to close this gap is using a coating provided on the internal wall of the thruster that reduces the gap between the propeller and the wall of the thruster. The coating used to close this gap must be able to stand up to tremendous shear force created by the turbulence of water as it thrusts pass the coating during operation. At the same time, the coating must also be forgiving enough so that the propeller does not get damaged should the propeller come in contact with the coating due to expansion of the nozzle and/or forces placed on the propeller in heavy seas.

In addition, since time is money, removing the Kort off of a vessel in dry dock and sending it to a factory for coating is both costly and time consuming. Therefore, what is needed in the vessel maintenance industry today is a coating and a process for coating Kort nozzles in situ for reducing the clearance between the propeller and shroud quickly and efficiently. The process and apparatus of the present invention achieves these objectives and is further described below.

### SUMMARY OF THE INVENTION

The present invention provides a process for thermally spraying a thermoplastic/thermal set (with or without filler) composition to the interior portion of the of the Kort nozzle barrel to reduce the clearance between the propeller blade tips and the nozzle interior.

The present invention provides an apparatus for automatically spraying a Kort nozzle barrel with a thermoplastic/thermal set (with or without filler) composition so as to reduce the clearance between the propeller blade tips and the nozzle interior.

The present invention also provides a Kort nozzle barrel and propeller/impeller system wherein the immediate area of the Kort nozzle barrel that comes in close proximity to the tips of the propeller/impeller contains a thermoplastic layer that reduces the gap between the wall of the Kort nozzle barrel and the tips of the propeller/impeller to virtually zero clearance. That is, the gap between the wall of the Kort nozzle and the propeller tip is substantially the smallest absolute clearance possible without risking the possibility of engineering failure. The process of the present invention can be used to coat new or used Kort nozzle barrels.

### BRIEF DESCRIPTION OF THE FIGURES

FIG. 1 shows a cutaway side view of a thruster and propeller shaft of a Kort nozzle barrel.

FIG. 2 shows a partially angled view of the in situ spray system of the present invention.

FIG. 3 shows a left side view of the spray system of the present invention.

FIG. 4 shows a back view of the spray system of the present invention.

FIG. 5 shows one of the multiple spray heads provided on the spray system of the present invention.

FIG. 6 shows a heating head on the spray system of the present invention.

FIG. 7 shows a machining head on spray system of the present invention.

FIG. 8 shows a front view of the spray system of the inside of the Kort nozzle barrel without the propeller with the spray system positioned inside the nozzle barrel.

FIG. 9 shows a cutaway left side view of the spray system of the present invention positioned inside the Kort nozzle barrel to be sprayed.

FIG. 10 shows a partially angled view of the spray system of the present invention positioned inside the Kort nozzle barrel to be sprayed.

### DESCRIPTION OF THE INVENTION

For over 100 years screw driven propellers and impellers have been used to propel marine vehicles. Over the years, the technology of the propulsion drives has changed incredibly. However, the technology of the propeller/impeller, aside from sizes and shapes, has remained relatively unchanged.

As a propeller/impeller turns, water is drawn in and is accelerated through the flywheel action of a propeller/impeller increasing the higher-velocity stream of water behind (aft) the propeller/impeller. Accelerating the water by the action of pulling water in and pushing water out at a higher velocity is commonly known as adding momentum to the water. This change in momentum or acceleration of the water (hydro-flow) results in a force called “thrust.” A curvature of the propeller/impeller blade creates low-pressure on the front of the blade, thus inducing lift, much like the propeller on an airplane. With a marine propeller/impeller, the lift is translated into horizontal movement.

The spinning blades of the propeller/impeller produce hydro-flow thrust, which can depend upon many factors. Examples of such factors include volume of water accelerated per time unit, propeller/impeller diameter, velocity of incoming hydro-flow, density of water, and the SHP (shaft horsepower) accelerating the propeller/impeller, and the gap between the propeller and the wall of the thruster. Reducing this gap reduces the thrust pressure lost due to blow-bye and therefore increases thrust and decreases fuel consumption. In this time and era where fuel costs are forever increasing, an increase in the thrust of vessel can reduce the amount of fuel used and drastically reduce the fuel costs associated with a given vessel. In the case where the distance a vessel can travel and/or the time a vessel can stay at sea is limited by its fuel capacity, reducing the fuel consumption of a given vessel will allow the vessel to travel further or spend more time at sea before requiring fueling.

Needless to say, as in any motorized industry, great expense and effort has been put into the improvement of efficiency and power or hydro-flow thrust, of propeller/impeller thrust propulsion devices. However, even with the large amount of money spent to increase the efficiency and power of propeller/impeller thrust propulsion devices, a process for sufficiently reducing the gap between the propeller/impeller and the wall of the thruster so as to reduce drag, cavitations and friction has not yet been developed. Accordingly, there is a need in the field for a process for thermally spraying a thermoplastic material on the inside wall of the thruster so as to reduce the gap between the propeller/impeller and the thruster to virtually zero, thereby reducing drag, friction, cavitations and blow-bye of the thruster device.

Kort nozzles, as constructed, are very rarely concentric and the gap between the propeller blade tips and the nozzle barrel are purposely designed to ensure clearance. As a result there is inefficiency in the thrust, which can be achieved, as thrust pressure is lost due to blow bye. Cavitation is increased due to the induce turbulence due to blow bye. The concentration of water movement in the nozzle produces increased wear on applied coatings inside the barrel tube.

The present invention is provides an apparatus for thermally spraying an interior surface of a Kort nozzle and a thermal spray process that is designed to coat the inside thruster so as to reduce the gap between the propeller/impeller in order to reduce the gap between the thruster wall and the propeller/impeller to almost zero so as to increase the thrust and fuel efficiency of the hydro-thruster.

The present invention also provides a thermal spray composition that is thermally sprayed, an apparatus for applying the thermal spray composition and a process for applying the thermally sprayed composition to a Kort nozzle in situ that reduces the clearance between the propeller blade tips and the interior of the Kort nozzle. The coating is applied at a minimal thickness over the entire interior of the cylinder. A thicker coating is applied to the area in which the propeller blades rotate, ensuring that the inside diameter of the nozzle is equal to the diameter circumscribed by the blade tips. This process assures that there is substantially no gap between the propeller blade tips and the wall of the Kort nozzle barrel. A zero-degree gap results in increased pressure and momentum while preventing cavitations (the bubbles that form when a liquid is being pumped), dampening sound and eliminating “blow-by” (unburned fuel and exhaust gases that escape around the piston rings and enter the crankcase, potentially compromising engine performance).

When the coating is applied on the inside surface of a Kort nozzle, the available thrust is increased with no additional energy input. The coating makes the nozzle more efficient, substantially reducing fuel consumption and protecting the structure from corrosion. The coating can be used on both new and used Kort nozzles and can stand up to a concentration of water movement that normally produces severe wear on the inside of the nozzle, which further reduces efficiency. The process of the present invention can be used with the apparatus provided here in or any other thermal spray device designed to apply coatings on a circular surface.

The proprietary thermal spray device designed for coating Kort nozzles uses specialized software and a robotic arc to follow the contour of the wall of the Kort nozzle and remediate concentricity imperfections that may exist as a result of wear or from manufacturing. Kort nozzles are rarely manufactured concentric; machining a perfectly concentric barrel would be time-consuming and expensive. The coating can be applied while the vessel is out of the water and the Kort nozzle is still installed on the vessel, reducing the labor and time associated with removing the nozzle from a vessel to apply the coating.

Application of the near zero-degree clearance coating can provide fuel savings between about 15 and 20% and in some cases even higher. Using the process of the present invention, a normal gap of about ¾-1.5 inch between the blade and nozzle can be reduced down to less than about ⅛ inch, which for the purpose of this application is substantially zero clearance. This would not only reduce fuel consumption of the vessel but also provide the vessel with additional thrust with less rpm. The applied coating also reduces the wear and tear on the engine shaft, and allows the vessel to travel farther and spend more time out on the water due to the decreased fuel consumption. Allowing greater range and additional time at sea can be a significant factor in the fishing industry.

In particular, the process for thermally spraying a thermoplastic composition to the interior portion of the of the Kort nozzle barrel of the present invention can be applied uniformly to a minimum thickness over the entire nozzle interior or to particular thickness at the point where the propeller tips are in close proximity to the Kort wall. If a thin layer is applied to the entire inner surface of the Kort nozzle, a thicker coating is applied to the area circumscribed by the propeller blades. This area is built up to a thickness, which ensures that the inside diameter of the nozzle is smaller than the diameter circumscribed by the blade tips with consideration given to the fact that the Kort nozzle is almost never absolutely concentric. An appropriate center-point inside the nozzle is established and excess material is machined away so that the dimensions between the propeller blade tips and the nozzle inside diameter have nearly a zero degree clearance. That is, there is virtually no gap between the propeller blade tips and the wall of the Kort nozzle barrel.

The process for thermally spraying a coating on an interior surface of a Kort nozzle of a vessel in situ comprises several steps. First, with the vessel on dry-dock the propeller must be removed from the propeller shaft of the vessel so as to provide room for the Kort nozzle of the vessel to be sprayed. Once the propeller is removed a thermal spraying device is attached to the propeller shaft so as to establish a center axis within the Kort nozzle. Once attached the thermal spraying device is activated so as to start producing a thermal spray coating on the inside surface of the Kort nozzle. As the thermal spray is released, the thermal spray device is rotated about the fixed propeller shaft at a controlled rate for a predetermined amount of time so as to thermally spray a predetermined thickness on the inside surface of the Kort nozzle.

The spraying and rotation of the thermal spraying device can be controlled by a computer and/or controller which can be programmed to regulate the rate of rotation of the thermal spraying device as well as the amount of time of rotation. Programming this information into the CPU and/or controller that is in communication with the thermal spraying device produces the predetermined thickness on the inside surface of the Kort nozzle. The controller/CPU can be programmed to vary the thickness of the coating according to the position of the thermal spraying device.

In addition, the controller/CPU can be programmed with the amount of fuel and/or thermal spray composition being supplied per unit of time so as to produce the coating thickness required on the Kort nozzle inner surface. The apparatus used in the process of the present invention comprises of a rotary seal which centers on the propeller shaft and delivers all gas air and powder required for the application of the spay coating. Further the apparatus contains a machining cutting head for the purpose of machining the coating after application to establish concentricity with respect to the propeller blade.

Once the coating is thermally sprayed on to the inside surface of Kort, the process of the present invention can include a step wherein at least one thermal spray head of the thermal spray device is exchanged with a rotary cutting assemble. Once inserted the controller/CPU can be programmed to begin rotating the thermal spray device so as to machine the thermal spray composition sprayed on the inside surface of the Kort nozzle to the exact diameter of the removed propeller tips thereby reducing blow-by during operation. In the alternative, once the proper amount of thermal spray is applied, the thermal spray device can be removed from the propeller shaft and the propeller reattached so that the coating is etched by the tips of the propeller to produce a zero clearance.

The process of the present invention can further comprise moving the thermal spray device on an x-axis, y-axis or z-axis so as to maintain a predetermined spray distance between the thermal spray device and the surface being coated. Maintaining the proper distance away from surface being coated is important in making the best conditions for curing of the thermoplastic material on to the surface. Programming the movement of the thermal spray device also allows thermal spray materials to be deposited where needed and to what amount.

The process and apparatus of the present invention can use a thermal spray composition selected from the group consisting of clad epoxy/polyethylene, epoxy/nylon, epoxy/Pebax, a bond coat composition having inorganic filler, vermiculite filled nylon, nylon co-polymer, vermiculite filled polyethylene and mixtures thereof. The thermal spray composition can also contain at least one compound selected from the group consisting of anti-corrosion, anti-cavitational, antifouling, ceramic, mineral, vermiculite, and mixture thereof.

In particular, the thermoplastic material used with the apparatus and process of the present invention can be selected from the group consisting of Polyethylene, nylon, Pebax (polyester/amid), EAA. The thermal set materials consist of Epoxy FBE and manmade plastic materials. The fillers consist of inorganic fillers, abrasive materials and mixtures thereof. For example, FBE can be mixed with Nylon or polyethylene to produce the thermoplastic composition that is thermally sprayed on the wall of the Kort nozzle barrel. Other compositions include FBE/Nylon; Epoxy/Pebax (polyester/amid); Epoxy with EAA or EMAA or Nylon; EAA with inorganic fillers, such as, ceramics or minerals such as vermiculite. The coating composition used to coat the Kort nozzle must not contain any metallic additives since doing so would cause an electrolysis effect and essentially make the complete vessel into a battery. That is, although the propeller area of the Kort nozzle is usually made from stainless steel with the weld areas and external shell made from low carbon steel. The addition of another metal in a coating would cause electrolysis to occur. In the alternative a bond coating can be applied first then a metal containing anti-fouling coating so as to prevent the metal containing antifouling coating from coming in direct contact with the stainless steel of the Kort nozzle proper and therefore does not cause electrolysis.

More particular, the material used for the thermal spray device of the present invention can be specifically designed for protection against cavitations, has anti friction properties to allow for reduced drag in the Kort Nozzle barrel and thereby increase thrust even more. Moreover, the material used can be specifically designed as a thermal plastic the breaks off in pieces as apposed to sheets in the event of an impact with foreign debris and/or by d the propeller blade tips.

The process for spraying and machining a thermoplastic composition thermally sprayed onto the interior portion of the of the Kort nozzle barrel while the vessel is out of the water and the Kort is still installed on the vessel reduces the labor and time associated with removing the Kort from a vessel to apply the thermoplastic coating.

In the alternative, another method of the present invention is removing the Kort from a vessel while the vessel remains in the water using a specially designed barge to do so, coating the Kort according to one of the methods described above, and replacing the Kort back on to the vessel while it remains in the water. This method is especially useful with very large vessels such as tankers, aircraft carriers, submarines and other very large vessels, since often taking these types of large vessel out of the water is either cost prohibitive and sometimes impossible. If this method is used, the propeller shaft is replaced by a stand configured to position the thermal spray device at the center axis within the nozzle barrel. The rest of the process is same as described above. Thus, by removing the Kort and spraying it on land and then replacing it while the vessel remains in the water the method of the present invention can be used with small vessels as well as large and very large vessels a like.

Whether the vessels are taken out of the water or the vessel remains in and Kort nozzle is removed, the thermal spray device that is used attaches to the propeller shaft or stand establishes a center axis within the nozzle barrel. The machine also has a rotary distributor that feeds a thermally spray device into the region to be sprayed. With the propeller shaft or stand fixed, the automatic machine turns the thermal spray device at a controlled rate while simultaneously moving the thermal spray device transversely coordinated to RPM of the rotating device. As stated above the thermal spray device is designed so that it is capable of being moved on a Z-axis as well as the x and y-axis. Movement on the Z-axis is important in order to move the spray gun, torches, and machine cutter towards and away from the wall of the Kort nozzle barrel so as to maintain a spray or device distance with respect to the shape of the inside of the Kort nozzle barrel. The Y axis is important to align the device with the propeller shaft and Kort nozzle center. After spraying of the Kort nozzle a rotary cutting assemble is attached to the device to machine the polymer coating to exact dimensions to match the diameter of the propeller tips.

As stated above, very few Kort nozzle barrels are machined to perfect concentricity since the clearance between the propeller tips and the wall of the nozzle is usually substantial enough so as to allow for any imperfections in the shape of the Kort nozzle that may occur. That is, the gap between the propellers and the wall is significant enough so as to assure that the propellers do not come in direct contact with the wall of a Kort nozzle barrel should the Kort nozzle barrel have imperfections. Doing so would result in damaging the propellers. Therefore, designing the thermal spray device of the present invention so that it can move on the Z-axis is important so that the device is capable of following the often-imperfect contour of the inner wall of the Kort nozzle so as to deposit thermoplastic material to compensate for the imperfect contour. That is, the thermal spray device of the present invention can be directed, using computer software and CPU, to follow the contour of the wall of the Kort nozzle and correct any imperfections that may exist either from wear or manufacturing. This allows manufacturers of the Kort nozzle barrels to produce perfectly concentric Kort nozzles without increasing machining cost in order to do so.

As stated above, the material used to close the gap in the Kort nozzle barrel can be a clad epoxy/nylon bond coat composition with a clad epoxy/polyethylene, epoxy/nylon, or epoxy/Pebax (polyester/amid) secondary coat composition having an inorganic filler such as ceramic or mineral, i.e. vermiculite. In addition, other secondary coats that can be used are vermiculite filled nylon and nylon co-polymer or vermiculite filled polyethylene. As stated above, other polymer compositions may be used as well.

In addition to closing the gap between the propeller and the interior wall of the Kort, the applied coating can also provide anti-corrosion protection and anti-cavitations. In some cases, if an antifouling protection is desired, an epoxy/nylon composition and vermiculite filled nylon/nylon co-polymer composition can be applied and a nonmetallic anti-fouling additive applied to the thermoplastic coating after the coat has been machined to the proper clearance.

The applied coating provides anti-cavitational characteristics by reducing the gap between the outer wall of the Kort and the propeller tips and therefore reducing the amount of turbulence produced in this region. In addition, unlike the stainless steel and steel that the Kort nozzle barrel is constructed from, the thermoplastic coating applied is more elastic and therefore acts as a shock absorber for the cavitational bubbles that burst against the coated surface. In addition to preventing cavitations, the applied thermoplastic coating will reduce the sound produced upon bursting of the cavitations bubbles against the wall of the Kort. This is often important in Navy ships since it would reduce the risk of being detected by sonar from long distances away.

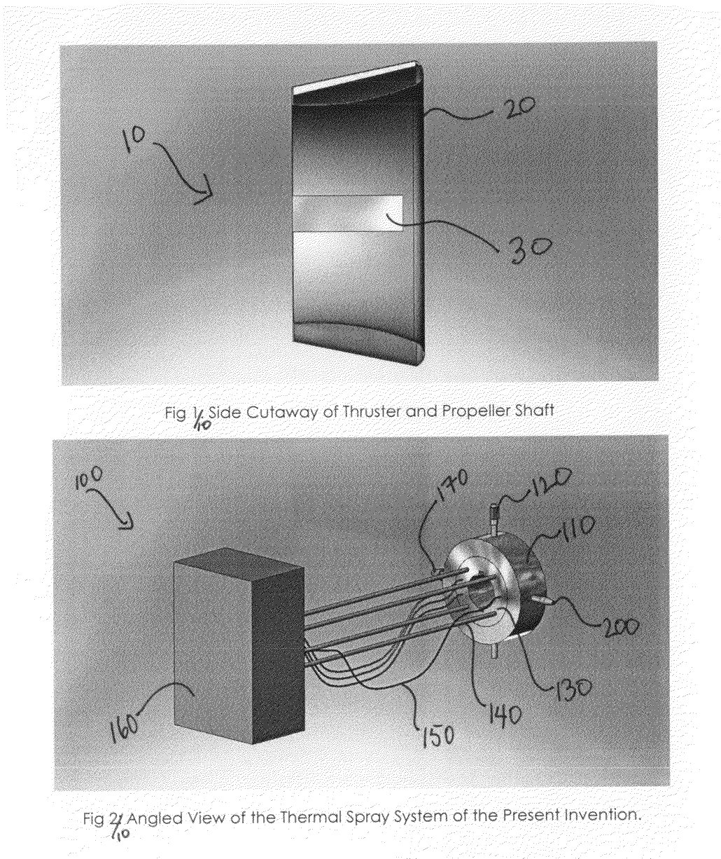

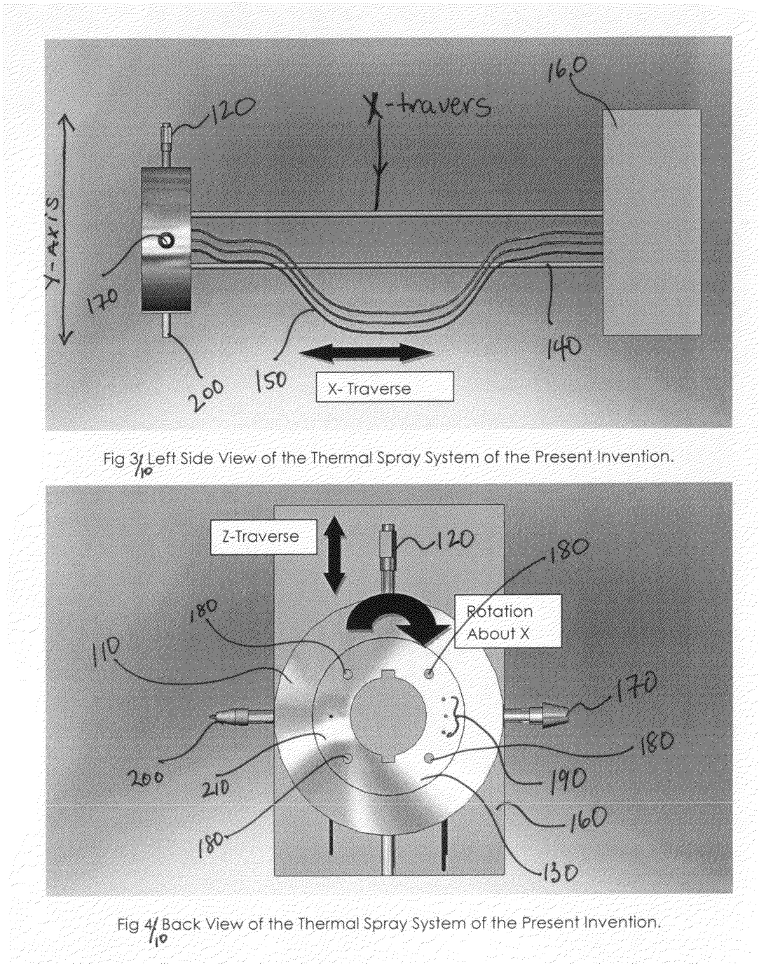

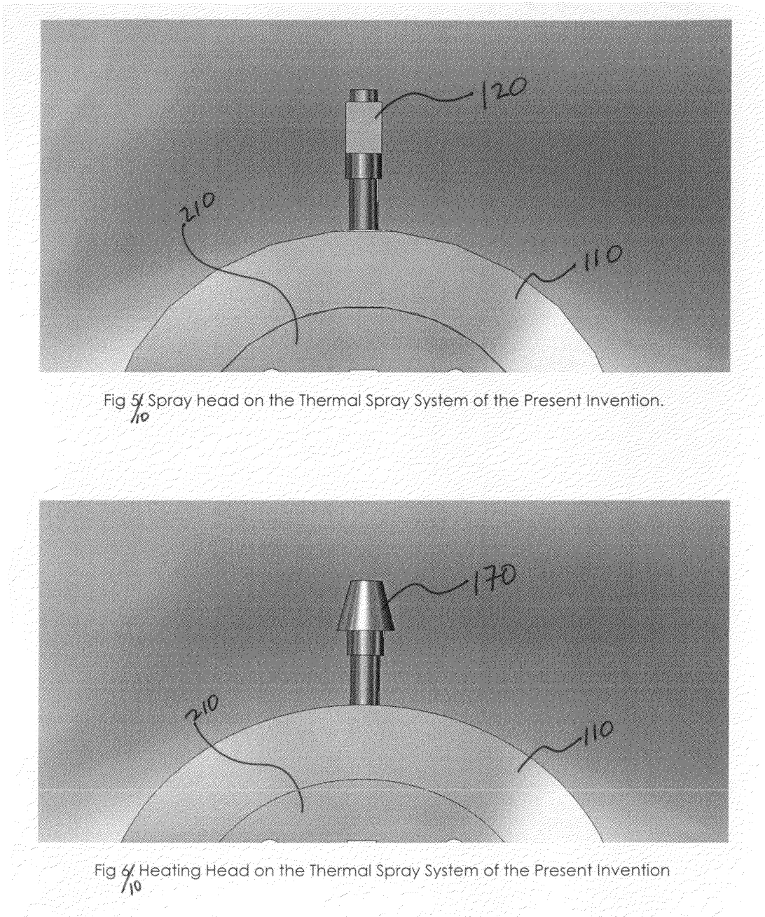

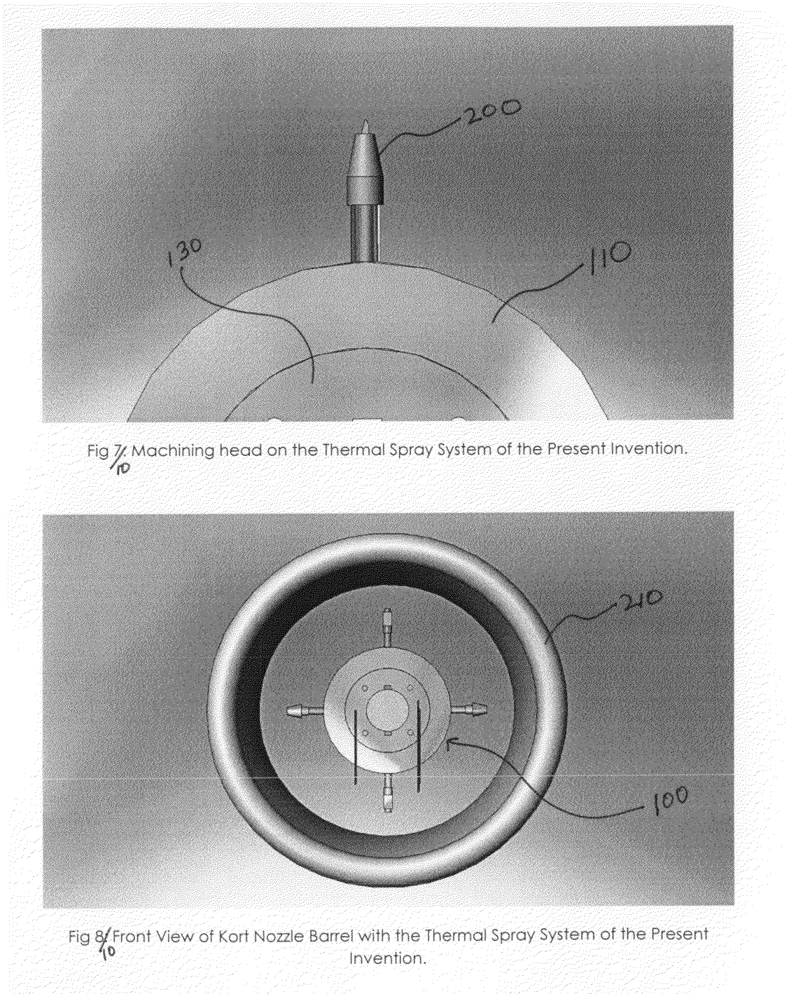

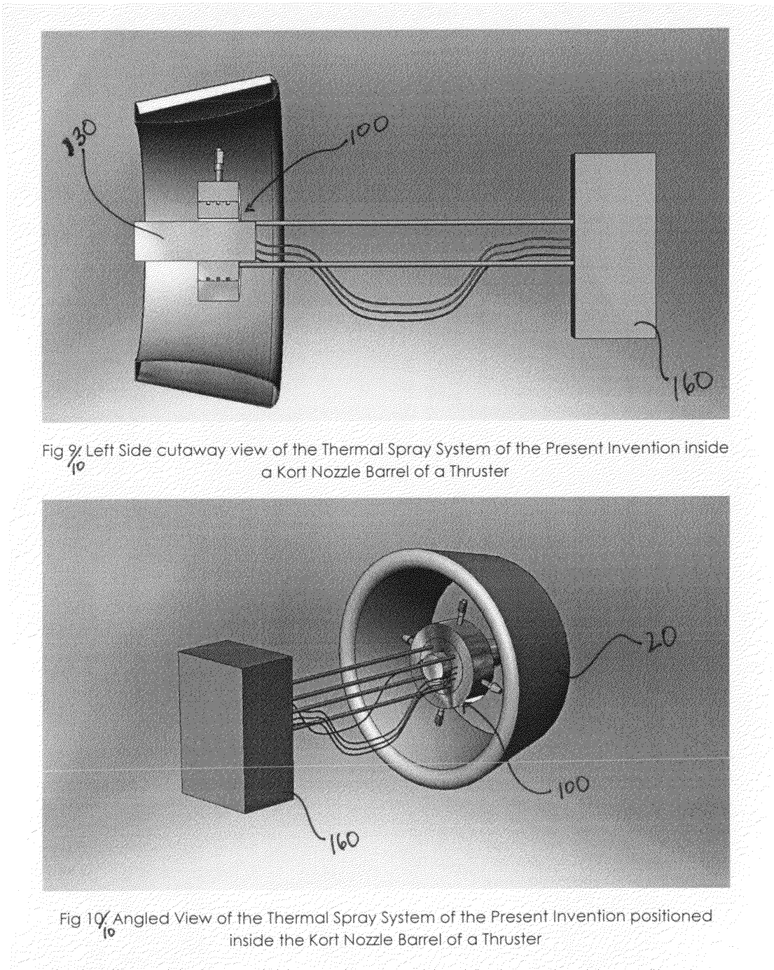

The Kort nozzle barrel spraying system is further described in FIGS. 1-10. FIG. 1 shows a side cutaway of a thruster (20) and propeller shaft (30) of a Kort nozzle barrel (10). FIG. 2 shows an angled view of the in situ thermal spray system (100) of the present invention. The system comprises a controller (160) that is attached to a stationary hub (130) having a rotating spraying device (110) in communication with the hub (130). The rotating spraying device (110) is configured to rotate about the stationary hub (130). The stationary hub (130) is attached to the controller (160) by a multiplicity of structural arms (140). The structural arms (140) can have a hollow core so as to provide a passage to supply fuel and thermal spray compositions to the spraying device (110). In the alternative, feed and communication lines (150) can be attached to the stationary hub (130) at one end and the controller (160) at the other so as to assist in communication and providing supply feeds to the rotating spraying device (110).

Rotating spraying device (110) is equipped with a thermal spray head (120) a heating torch head (170) a machining head (200). The rotating spraying device (110) sprays the thermal spray composition on the inner surface of the Kort nozzle and the heating torch head (170) preheats the surface as it rotates and also heats the sprayed on thermal spray composition to assure that any incompletely cured thermal spray compositions are fully cured. This apparatus is used with the process of the present invention and the controller (160) adjusts the positioning of the thermal spraying device (110) on the x-axis, y-axis, and z-axis in order to position the thermal spray head (120) at the proper distance away from the inner surface of the Kort nozzle so as to assure proper coating of the surface. Movement on the other x-axis allow the process to coat the entire Kort nozzle at the same or different thicknesses or only portions of the surface can be coated.

FIG. 3 shows the left side view of the spray system of the present invention. The x-traverse and the y-axis are marked in this figure. FIG. 4 shows the back view of the spray system (100) of the present invention. As shown the spraying device (110) rotates about the x-axis while the stationary hub (130) remains in place. The stationary hub (130) has several attachment ports for the rotating arms (210) and several ports for supply feeds (190). The three different heads are shown in this figure. The thermal spray head (120) is shown at 12 o'clock dead center. The heating torch (170) is shown 90 degrees clockwise from the thermal spray head (120) and the machining head (200) is shown at about 180 degrees clockwise from the heating torch (170). The process using this device adjust the rotational rate of the thermal spraying device (110) about the x-axis which is attached to the propeller shaft so that the heating torch (170) can properly preheat the surface to be sprayed and the thermal spray head (120) sprays the thermal spray composition onto the inner surface of the Kort nozzle. The spray device can be moved so as to coat the complete surface at different thicknesses or spraying can be concentrated to a particular area to build a greater thickness for preventing blow-bye.

FIG. 5 shows one of the multiple spray heads (120) on the spray system of the present invention. FIG. 6 shows the heating head (170) on the spray system of the present invention. FIG. 7 shows the machining head (200) on spray system of the present invention. FIG. 8 shows the front view of the spray system (100) inside of the Kort nozzle barrel (210) wherein the propeller has been removed and the spray system positioned attached to thermally spray the surface in situ.

FIG. 9 shows the left side cutaway view of spray system (100) of the present invention positioned inside the Kort nozzle barrel (210) to be sprayed. As shown the spray system (100) is attached to the propeller shaft of the Kort nozzle barrel. Finally, FIG. 10 shows an angled front view of the spray system (100) of the present invention positioned inside the Kort nozzle barrel to be sprayed.

In addition to attaching the spray system (100) described above to the propeller shaft of the Kort nozzle barrel; an articulating robotic arm can be used to do the same motion and falls within the general concept of the present invention.

The overall benefits of spraying the coating of the present invention onto the Kort nozzle barrel include protecting the structure from corrosion, preventing cavitations, dampening sound, reducing blow-bye, increasing thrust and decreasing fuel consumption.

Although the method and apparatus is discussed for the Kort nozzle barrel the invention can also be used in other applications such as Water Thrusters and water Jets propelling devices. A water thruster is a propulsion system for controlling the direction of a vessel underway at low speeds. One embodiment of a water thruster contains six thruster nozzles installed around the hull that can be used individually or in combinations so as to maneuver the boat forward, backward, laterally or turned on its axis. The impeller pumps are operated by water cooled reversible DC electric motor which allows the thruster apparatus to operate for long periods. As with the Kort nozzle barrels applying a coating as described above would reduce blow-by and increase the thrust while reducing fuel consumption.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A process for thermally spraying a coating on an interior surface of a Kort nozzle of a vessel in situ comprising:
a. removing a propeller from a propeller shaft within said Kort nozzle of said vessel to be sprayed;
b. attaching a thermal spraying device to said propeller shaft so as to establish a center axis within said Kort nozzle;
c. activating said thermal spraying device to produce a thermal spray; and
d. rotating said thermal spraying device about said fixed propeller shaft at a controlled rate for a predetermined amount of time so as to thermally spray a predetermined thickness on said inside surface of said Kort nozzle.

2. The process of claim 1 further comprising programming a rate of rotation of said thermal spraying device and an amount of time of rotation into a controller that is in communication with said thermal spraying device thereby controlling said rotation of said thermal spray device so as to produce said predetermined thickness on said inside surface of said Kort nozzle.

3. The process of claim 2 wherein the controller comprises a computer-processing unit (CPU).

4. The process of claim 2 further comprising programming said controller to provide said thermal spraying device with a predetermined amount of fuel and/or thermal spray composition so as to produce said predetermined thickness on said inside surface of said Kort nozzle.

5. The process of claim 1 further comprising exchanging at least one thermal spray head of said thermal spray device with a rotary cutting assemble;
rotating said thermal spray device so as to machine said thermal spray composition sprayed on said inside surface of said Kort nozzle to the exact diameter of the removed propeller tips wherein reducing blow-by during operation.

6. The process of claim 1 further comprising moving said thermal spray device on an x-axis, y-axis or z-axis so as to maintain a predetermined spray distance of said thermal spray device while spraying said thermal spray composition.

7. The process of claim 1 wherein said thermal spray composition is selected from the group consisting of clad epoxy/polyethylene, epoxy/nylon, epoxy/Pebax, a bond coat composition having an inorganic filler, vermiculite filled nylon, nylon co-polymer, vermiculite filled polyethylene and mixtures thereof.

8. The process of claim 7 wherein said thermal spray composition further comprises at least one compound selected from the group consisting of anti-corrosion, anti-cavitational, antifouling, ceramic, mineral, vermiculite, and mixture thereof.

9. The process of claim 1 wherein the predetermined thickness on said inside surface of said Kort nozzle ranges from about ⅛ inch to about 2 inches.
